(19) United States
(12) Patent Application Publication
(10) Pub. No.: US 2017/0287482 A1
(43) Pub. Date: Oct. 5, 2017

(54) IDENTIFYING SPEAKERS IN TRANSCRIPTION OF MULTIPLE PARTY CONVERSATIONS

(71) Applicant: SpeakWrite, LLC, Austin, TX (US)

(72) Inventor: Richard Jackson, Austin, TX (US)

(73) Assignee: SpeakWrite, LLC, Austin, TX (US)

(21) Appl. No.: 15/479,695

(22) Filed: Apr. 5, 2017

Related U.S. Application Data
(60) Provisional application No. 62/318,288, filed on Apr. 5, 2016.

(51) Int. Cl. G10L 15/26; G10L 15/04; H04M 3/56; G10L 21/0272

(52) U.S. Cl. CPC G10L 15/265; G10L 21/0272; G10L 15/04; H04M 3/56

(57) ABSTRACT

A method and system in which a transcription of multi-party communication is provided. A plurality of speakers are recorded using any of a variety of recording devices. A copy of the recording is processed through a diarisation process to create a final diarisation product and a second copy of the recording is processed through a transcription process to create a final transcription product. The final diarisation product is used to differentiate individual speakers of the plurality of speakers in a final transcript. The final transcript and audio samples of each of the voice prints identified through the diarisation process are presented to a reviewer to determine the identity of each of the differentiated individual speakers. The identity of the each of the differentiated individual speakers is then inserted into the final transcript.

### PRIORITY STATEMENT UNDER 35 U.S.C. §119 & 37 C.F.R. §1.78

This non-provisional application claims priority based upon prior U.S. Provisional Patent Application Ser. No. 62/318,288 filed Apr. 5, 2016 in the name of Richard Jackson, entitled “IDENTIFYING SPEAKERS IN TRANSCRIPTION OF MULTIPLE PARTY CONVERSATIONS OR MEETINGS THROUGH VOICEPRINT AND SPEAKER DIARISATION” the disclosure of which is incorporated herein in its entirety by reference as if fully set forth herein.

### BACKGROUND OF THE INVENTION

In the transcription of an audio record of multiple speaker conversations, interviews, meetings and other interactions, it is highly valuable if the individual persons speaking can be identified by name rather than just specified as the “next speaker” or by some similar designation.

Often in these multiple party situations there is a substantial amount of disorganized and unstructured conversation and interplay, and overlap, between the parties, with the speakers changing frequently, sometimes with participants speaking over each other, and with varying quality of input and audio resulting therefrom. It is, therefore, virtually impossible for the person or software providing the transcription to accurately and predictably identify the person speaking in the instance of each position in the audio. Trying to identify and designate the identity of the speaker simply by use of the transcriptionist' s hearing is unpredictable and unreliable. Presently available dictation and transcription systems lack the ability to distinguish the speaker and to provide a complete and reliable transcription of the conversation.

There is a need, therefore, for a dictation and transcription system that allows for the efficient dictation, delivery and storage of a transcript of a multi-party conversation in which the identify of each of the speakers is correctly and reliably identified.

### SUMMARY OF THE INVENTION

According to various embodiments of the present invention, a method and system provide for the transcription of multi-party communication wherein a plurality of speakers are recorded using any of a variety of recording devices known in the art. One copy of the recording is processed through a diarisation process in which the audio stream is partitioned into audio samples according to the speaker identity to create a final diarisation product A second copy of the recording is processed through a transcription process in which the recording is transcribed into text to create a final transcription product. The results of the final diarisation product are used to differentiate individual speakers of the plurality of speakers in a final transcription product. The final transcript and audio samples of each of the voice prints identified through the diarisation process are presented to a reviewer to determine the identity of each of the differentiated individual speakers. The identity of the each of the differentiated individual speakers is then inserted into the final transcript.

The foregoing has outlined rather broadly certain aspects of the present invention in order that the detailed description of the invention that follows may better be understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a block diagram depicting the audio recording of a multiparty event;

FIG. 2 is a block diagram showing one embodiment of the speaker diarisation process of the present invention;

FIG. 3 is a block diagram showing one embodiment of the transcription process of the present invention;

FIG. 4 is a block diagram showing one embodiment of the review process of the present invention;

FIG. 5 is a block diagram showing another embodiment of the speaker diarisation process of the present invention; and

FIG. 6 is a block diagram showing one embodiment of the final integration process of the present invention.

### DESCRIPTION OF THE PREFERRED EMBODIMENTS

The present invention is directed to improved methods and systems for, among other things, identifying speakers in transcription of multiple party conversations or meetings through voiceprint and speaker diarisation. The configuration and use of the presently preferred embodiments are discussed in detail below. It should be appreciated, however, that the present invention provides many applicable inventive concepts that can be embodied in a wide variety of contexts other than identifying speakers in transcription of multiple party conversations or meetings through voiceprint and speaker diarisation. Accordingly, the specific embodiments discussed are merely illustrative of specific ways to make and use the invention, and do not limit the scope of the invention. In addition, the following terms shall have the associated meaning when used herein:

“audio” means and includes information, whether digitized or analog, encoding or representing audio such as, for example, any spoken language or other sounds such as computer generated digital audio;

“audio stream” means and includes an audio file containing a recording of a conference from a telephone or mobile device;

“audio segment” means and includes a small section of audio used to determine which audio stream includes the active speaker;

“conference bridge” means and includes a system that allows multiples participants to listen and talk to each other over the telephone lines, VOIP, or similar system;

“data integration module” means and includes a system that maps information collected for a data entry system into a central record keeping system;

“diarisation” means partitioning an input audio stream into homogeneous segments according to the speaker identity;

“digital transcribing software” means and includes audio player software designed to assist in the transcription of audio files into text;

“electronic communication” means and includes communication between electrical devices (e.g., computers, processors, conference bridges, communications equipment) through direct or indirect signaling;

“meeting participant” means and includes any person who participates in a meeting, including by dialing into a meeting's conference bridge number or joining a meeting from a mobile device;

“mobile device” means any portable handheld computing device, typically having a display screen with touch input and/or a miniature keyboard, that can be communicatively connected to a meeting; and

“transcriptionist” means a person or application that transcribes audio files into text.

On many occasions, and in multiple situations (including conversations, multiple party meetings; interrogations; panel discussions; legal, legislative, or other hearings; etc.) audio is captured and recorded which then must be transcribed by live transcriptionists, by computer-aided voice recognition software, by digital transcribing software, or otherwise, and a written transcription prepared of all speakers and their words spoken during the recorded period.

These situations may take place by meeting participants gathered in a single environment or through some form of multi-party conference bridge or other conferencing system, including systems having electronic switches, servers, and/or databases and a plurality of communications end-points, and the embodiments are not limited to use in any particular environment or with any particular type of multi-party conferencing system or configuration of system elements.

Traditionally, the speakers were simply identified in the written transcription at the point in time when the audio changed from one speaker to the next with some generic indications such as “next speaker.” In many cases, the transcriptionist attempted to identify the speakers by listening to the sound of their voice and, based upon that alone, attempted to attribute that sound to a particular individual. However, due to the subjectivity of the transcriptionist' s efforts, the transcription was not reliable and even tended to be damaging and counterproductive when an incorrect identification was made.

By use of various embodiments of the present invention, a transcription service is able to provide transcriptions of multiple party transactions with unlimited numbers of speakers and in any configuration of settings, correctly distinguishing and identifying every speaker in the finished transcript with 100% accuracy.

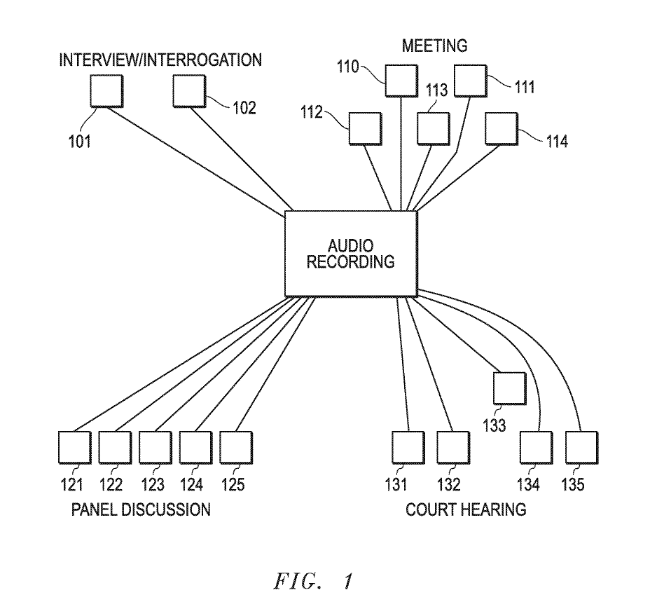

Referring now to FIG. 1 in which the audio of multiple party events is recorded or otherwise captured in any manner available, with no particular procedure or precautions needed to ensure the identification of the speakers involved. In this instance, the parties could include participants in an interview or interrogation 101, 102, a meeting 110, 111, 112, 113, 114, a panel discussion 121, 122, 123, 124, 125, a court hearing 131, 132, 133, 134, 135, or any other situation or circumstance in which multiple parties are conversing. The capture of the audio stream may take place through a single audio input device such as a microphone or a mobile device, or through a plurality of communicatively-connected audio input devices. A computer in electronic communication with the audio input devices, such as microphones, could be in the same room or in separate rooms, and could receive audio streams from the plurality of audio input devices in real time as they captured audio. In some embodiments, the audio stream may be filtered to reduce noise, to standardize amplitudes or for other reasons known in the art.

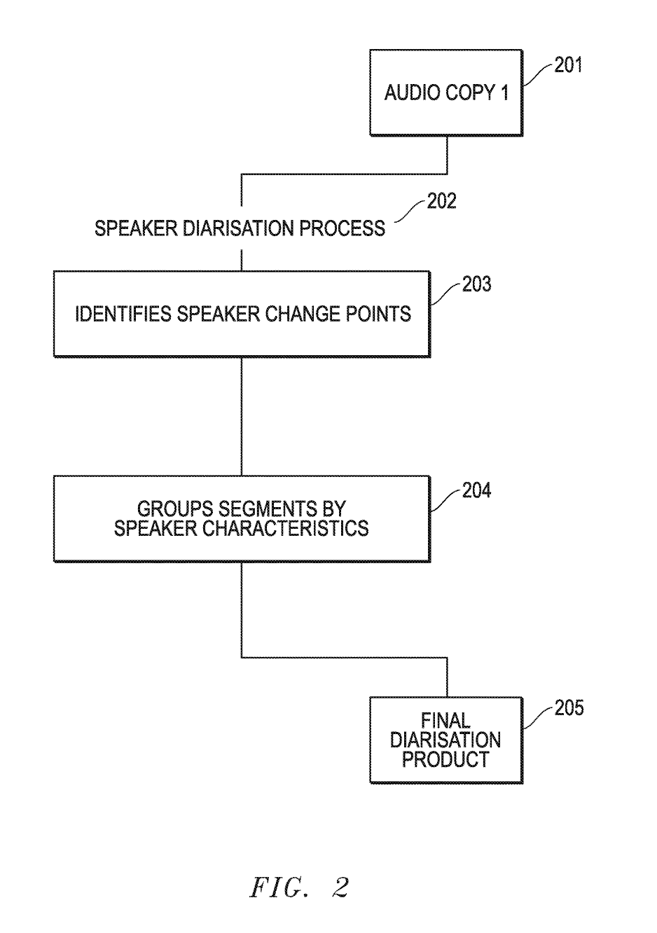

Referring now to FIG. 2 in which the audio is delivered by electronic communication for transcription. At that point, one copy of the audio 201 is sent directly through a speaker diarisation process 202 in which the audio stream is partitioned into audio samples, or homogeneous segments, according to the speaker identity. The speaker diarisation process structures the audio stream into speaker turns and provides the speaker's true identity. In other words, it is a combination of speaker segmentation and speaker clustering: the first aims at finding speaker change points 203 in an audio stream and the second aims at grouping together speech segments on the basis of speaker characteristics 204. This speaker diarisation process continues until the final transcription product 205 is completed, separate and apart from the transcriptionist's work in transcribing the contents of the audio stream.

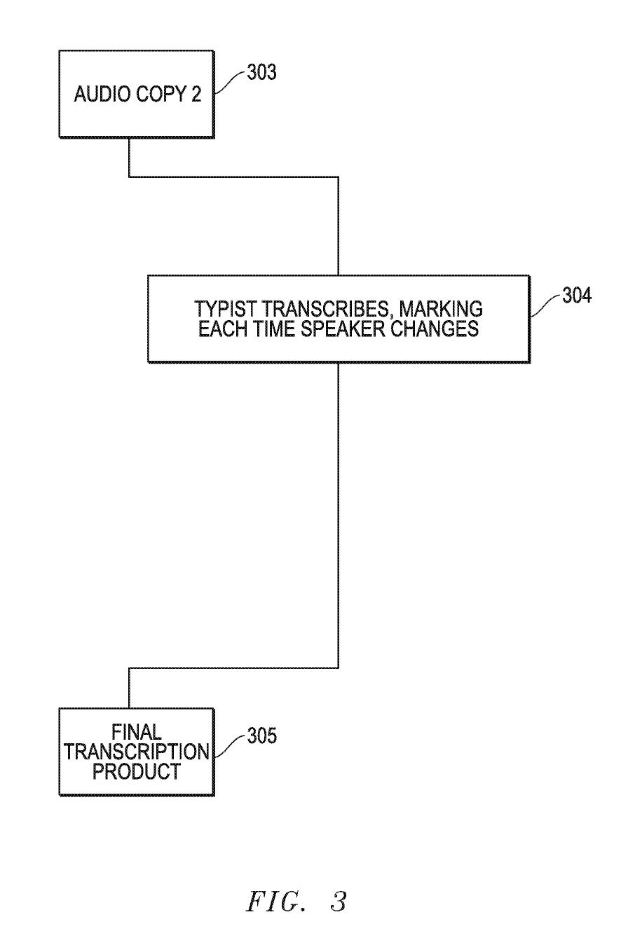

As seen in FIG. 3, another copy of the complete audio 303 is also delivered through electronic communication to the transcriptionist to be transcribed. In some embodiments this occurs at the same time the audio is proceeding through the speaker diarisation process 202. The transcriptionist may be any person or application that transcribes audio files into a text representation or copy of the audio. For example, a stenographer listening to spoken language from the audio source and converting the spoken language to text using a stenograph could be considered a transcriptionist for the purposes described herein. Alternatively, a speech-to-text software application operating on appropriate hardware could also be considered a transcriptionist.

During the course of the transcription, the transcriptionist makes a designation in the written transcription each time the speaker in the audio changes 304 using, in some embodiments, a unique identifier. This can be something descriptive such as an indication of “next speaker” or it can be any sort of designation or marking that allows a later unique identification of that spot in the completed transcription. The transcription process results in a final transcription product 305.

At the completion of the audio's transcription, the final transcription product 305 is compared to the final diarisation product 205. The voiceprint of each speaker on the final transcription product 305 is identified according to the results of the final diarisation product 205 and each speaker is independently identified on the transcript, for example, such as “Speaker 1”, “Speaker 2”, “Speaker 3”, etc. 402. At this stage, the transcript includes a transcription of the audio and a designation of the voiceprint corresponding to each audio segment.

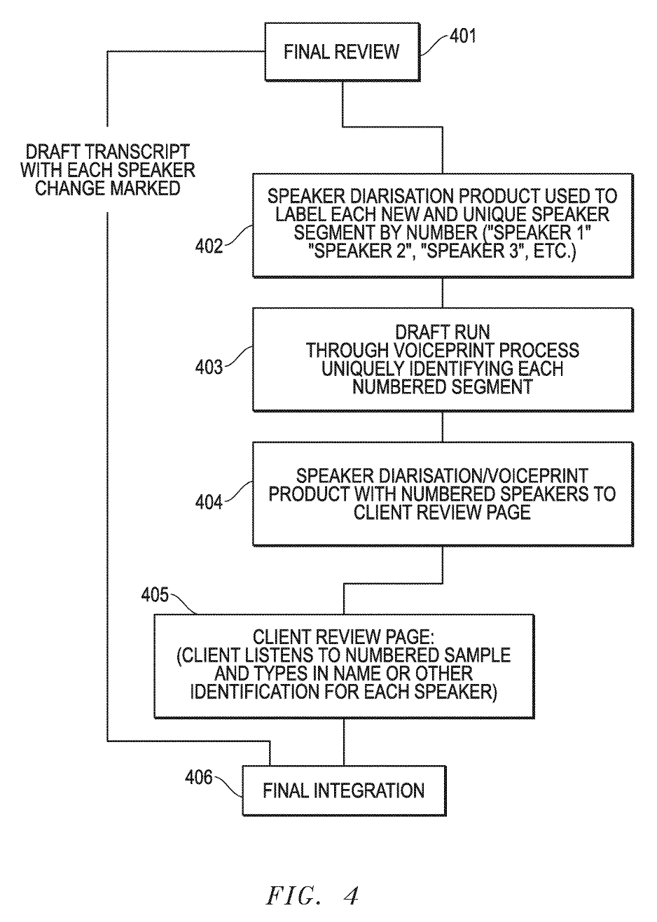

As shown in FIG. 4, the transcript is then presented to a reviewer, along with audio samples of each of the voice prints identified through the diarisation process. The reviewer can be affiliated with the party requesting the translation or not, but must have the ability to identify the voices present on the audio. The reviewer is any person or system that is capable of reviewing text transcribed from audio to confirm the accuracy of the transcription. If errors were made in the audio to text conversion, the reviewer identifies and corrects the errors. The reviewer could be a human reviewer of a previously computer generated speech to text transcript. Alternatively, a hardware and software system that contains the appropriate components to review a speech to text translation and confirm text accuracy is also a reviewer. A reviewer may also include human and non-human components, such as when a system includes a display system for displaying the original conversion to a human reviewer, an audio playback system for the human reviewer to listen to the original audio, and a data input system for the human reviewer to correct errors in the original conversion.

The reviewer can listen to the audio samples and assign an identity, such as a name, to each voice print, thereby identifying each speaker 403. For example, the reviewer can listen to a sample of the audio attributed to “Speaker 1” and identify the audio as corresponding to a specific individual. In some embodiments, this input can be provided through a graphical user interface and the reviewer can simply input the identification of the speaker as they are listening to the audio. The reviewer can listen to as many audio samples as desired of the unique voice of each of the participants involved in order to be certain of the identity.

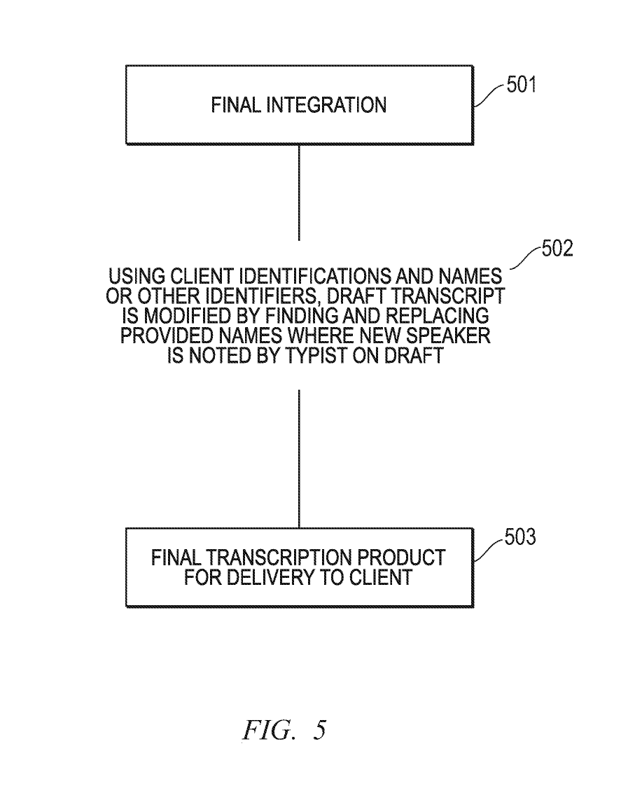

Using the input of these names or other identities from the reviewer, the final completed transcription is compared to the diarisation and voiceprint results as shown in FIG. 5, and the designations of the party identified as the actual speaker for each of the specific segments of the transcription is automatically inserted into the final transcription 502 according to the instructions and designations of the reviewer to create a final, integrated document in which the audio is transcribed and the speakers are correctly and accurately identified. In some embodiments, this final transcription with all speakers identified according to the instructions of the reviewer is then delivered to a client 503 as a finished product.

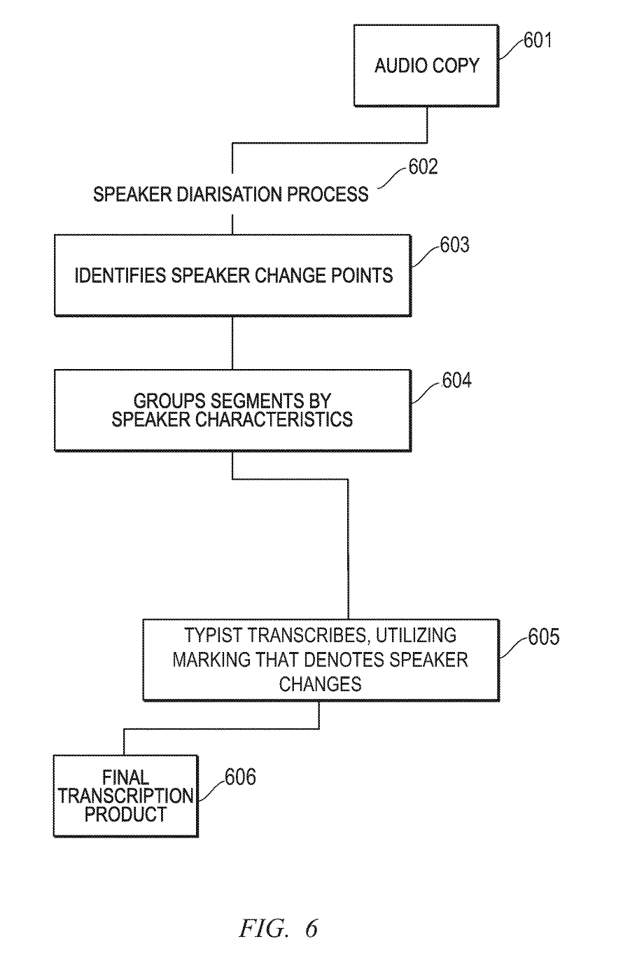

Referring now to FIG. 6 which shows an alternative embodiment of the present invention in which the audio is again delivered by electronic communication for transcription. In this embodiment, one copy of the audio 601 is sent directly through a speaker diarisation process 602 in which the audio stream is partitioned into audio samples according to the speaker identity. Once again, the speaker diarisation process 602 structures the audio stream into speaker turns and provides the speaker's true identity. In other words, it is a combination of speaker segmentation and speaker clustering: the first aims at finding speaker change points 603 in an audio stream and the second aims at grouping together speech segments on the basis of speaker characteristics 604.

The results of the speaker diarisation process 602 are fed directly into the transcription process 605 which enable to transcriber to better manage the transition from speaker to speaker. By using the output of the speaker diarisation process 602, the audio 601 can be enhanced by inserting a notation in the system that shows the start and stop point of each unique speaker. This allows the transcriptionist to know when and where new speakers start and identifies speaker transitions with nearly one hundred percent accuracy. In addition, the speaker identification process can then be merged or combined at this point to also provide the identification of each speaker based on segmentation. The transcription process results in a final transcription product 606. In some embodiments, a database can store the history of previously identified speakers by name and voice print.

The voiceprint of each speaker on the final transcription product 607 is identified according to the results of the final diarisation product 605 and each speaker is independently identified on the transcript, for example, such as “Speaker 1”, “Speaker 2”, “Speaker 3”, etc. At this stage, the transcript includes a transcription of the audio and a designation of the voiceprint corresponding to each audio segment.

As in prior embodiments, the final completed transcription is compared to the diarisation and voiceprint results as shown in FIG. 5 using the input of these names or other identities from the reviewer, and the designations of the party identified as the actual speaker for each of the specific segments of the transcription is automatically inserted into the final transcription 502 according to the instructions and designations of the reviewer to create a final, integrated document in which the audio is transcribed and the speakers are correctly and accurately identified.

While the present system and method has been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise. The term “connected” means “communicatively connected” unless otherwise defined.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of transcription methodologies known in the art, the detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

What is claimed is:

1. A method for transcribing multi-party communication, comprising:
recording a plurality of speakers;
processing a first copy of the recording through a diarisation process in which an audio stream is partitioned into audio samples according to speaker identity to create a final diarisation product;
processing a second copy of the recording through a transcription process in which the recording is transcribed into text to create a final transcription product;
using the final diarisation product to differentiate individual speakers of the plurality of speakers in a final transcript;
presenting the final transcript and audio samples of each voice print identified through the diarisation process to a reviewer to identify each of the differentiated individual speakers; and
inserting the identity of the each of the differentiated individual speakers into the final transcript.

2. The method of claim 1, wherein the diarisation process is a combination of speaker segmentation and speaker clustering.

3. The method of claim 1, wherein the plurality of speakers are recorded over a conference bridge.

4. The method of claim 1, wherein the plurality of speakers are recorded using a single audio recording device.

5. The method of claim 1, wherein processing a first copy of the recording through the diarisation process and processing a second copy of the recording through the transcription process occur simultaneously.

6. The method of claim 1, wherein the reviewer is a human.

7. The method of claim 1, wherein the reviewer reviews audio samples to identify each of the plurality of speakers.

8. A system for transcribing multi-party communication, comprising:
a recording device for recording a plurality of speakers;
a first processor for processing a first copy of the recording through a diarisation process in which an audio stream is partitioned into audio samples according to speaker identity to create a final diarisation product;
a second processor for processing a second copy of the recording through a transcription process in which the recording is transcribed into text to create a final transcription product, wherein the final diarisation product are used to differentiate individual speakers of the plurality of speakers in a final transcript; and
a reviewer who is presented with the final transcript and audio samples of each voice print identified through the diarisation process to identify each of the differentiated individual speakers, wherein the identity of the each of the differentiated individual speakers is inserted into the final transcript.

9. The system of claim 8, wherein the diarisation process is a combination of speaker segmentation and speaker clustering.

10. The system of claim 8, wherein the recording device includes a conference bridge.

11. The system of claim 8, wherein processing a first copy of the recording through the diarisation process and processing a second copy of the recording through the transcription process occur simultaneously.

12. The system of claim 8, wherein the reviewer is a human.

13. The system of claim 8, wherein the reviewer reviews audio samples to identify each of the plurality of speakers.
